(19) United States
(12) Patent Application Publication
(10) Pub. No.: US 2026/0147603 A1
(43) Pub. Date: May 28, 2026

(54) RE-USABLE MIGRATION PLANS FOR APPLICATION TRANSITIONS

(71) Applicant: Hewlett Packard Enterprise Development LP, Spring, TX (US)

(72) Inventors: Ignacio Aldama Perez, Alcobendas (ES); Marc Lambert, Mougins (FR)

(21) Appl. No.: 19/083,625

(22) Filed: Mar. 19, 2025

(30) Foreign Application Priority Data
Nov. 28, 2024 (EP) 24306996.0

(51) Int. Cl. G06F 9/455

(52) U.S. Cl. CPC G06F 9/45558; G06F 2009/4557

(57) ABSTRACT

According to an implementation, a computer system manages application migrations between computing environments through reusable migration plans. A processor receives and stores expert-defined migration templates in a repository, retrieves compatible plans based on application characteristics, and executes migrations through standardized parameters. The system separates complex configuration from routine execution, enabling non-expert operators to implement migrations through simplified interfaces while maintaining operational consistency through automated validation and recovery capabilities.

### BACKGROUND

Computing environments increasingly utilize containerization technologies alongside traditional virtual machines for application deployment and management. Containers provide isolated user-space instances that share an operating system kernel, while virtual machines encompass complete operating system instances running on virtualized hardware. Organizations maintain applications across virtual machines and containers, with varying deployment configurations and operational requirements.

Migration between virtual machines and containers involves technical considerations, including application state management, data persistence, and operational continuity. Applications can be stateless, where runtime data is not preserved between instances, or stateful, requiring data preservation during transitions. Container-based applications typically receive more frequent updates compared to virtual machine deployments, leading to increased migration frequency. Additionally, applications can be distributed across different computing environments, including private data centers and public cloud infrastructure, each with specific technical requirements for application deployment and management.

### BRIEF DESCRIPTION OF THE DRAWINGS

For a more complete understanding of this disclosure, and advantages thereof, reference is now made to the following descriptions taken in conjunction with the accompanying drawings, in which:

FIG. 1 is a block diagram of an implementation migration system;

FIG. 2 is a flowchart of an implementation method directed to the design phase of a migration plan;

FIG. 3 is a flowchart of an embodiment method directed to an execution phase of the migration plan;

FIG. 4 is a flowchart of an embodiment method for managing and executing migration plans; and

FIG. 5 is a flowchart of an embodiment method directed to creating and applying reusable migration plan templates.

### DESCRIPTION

The following disclosure provides many different examples of implementing different features. To simplify the present disclosure, specific examples of components and arrangements are described below. These are, of course, merely examples and are not intended to be limiting.

The particular implementations are merely illustrative of specific configurations and do not limit the scope of the claimed implementations. Features from different implementations may be combined to form further examples unless noted otherwise. Various implementations are illustrated in the accompanying drawing figures, where identical components and elements are identified by the same reference number, and repetitive descriptions are omitted for brevity.

Variations or modifications described in one of the implementations may also apply to others. Further, various changes, substitutions, and alterations can be made herein without departing from the spirit and scope of this disclosure as defined by the appended claims.

While the aspects are described primarily in the context of migrating between virtual machines and containers, they may also apply to migrations between different cloud environments, vendor platforms, and application versions. In particular, they may similarly apply to transitions between on-premise and cloud infrastructures, vendor application replacements, and containerized application upgrades. The migration techniques described can be applied across various computing environments, including telecommunications networks, enterprise data centers, and distributed cloud architectures.

In implementations, a proposed migration system implements reusable migration plans for transitioning applications between computing environments. The system can separate migration operations into design and execution phases, allowing for standardized deployment across multiple application instances. During the design phase, an expert can define migration parameters and procedures based on application requirements and target environments. The execution phase allows non-expert operators to implement these predefined plans through a simplified interface.

In implementations, the migration system accepts standardized input parameters, such as target cloud/location, migration mode, and target application. These parameters can be applied consistently across different migration scenarios, including transitions between virtual machines and containers, movements between cloud environments, or replacements of vendor applications. For stateful applications, the system can support the integration of data management operations through pre-migration and post-migration scripts, which can be defined using standardized formats.

Various migration strategies known in the industry, such as Canary, Blue-Green, and Standard, can be supported within the system. For example, the Canary strategy maintains concurrent operation of original and new applications during the transition, allowing for gradual migration. Blue-Green strategy implements sequential replacement, removing the original application before deploying the new version. The Standard strategy provides direct upgrade capabilities for cloud-native applications through built-in commands.

The system can include automated rollback capabilities that restore applications to their initial state if issues arise during migration. Compatibility checks between migration plans and target applications can help prevent the application of inappropriate migration strategies. The system can reduce complexity by automating deployment, removal, and data management operations while maintaining operational consistency.

The migration system can execute basic creation and deletion operations for stateless applications without additional data management procedures. The system architecture can support the scaling of migration operations across multiple application instances while maintaining consistent execution procedures. By standardizing migration processes and separating expert configuration from routine execution, the system can enable efficient management of application transitions across diverse computing environments. These and additional details are further disclosed below.

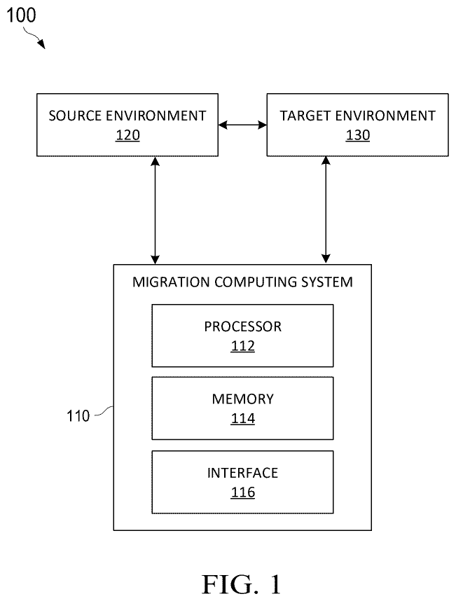

FIG. 1 illustrates a block diagram of an implementation migration system 100. The system implements standardized transitions between computing environments through a migration computing system 110 coupled to a source environment 120 and a target environment 130.

The migration computing system 110 includes a processor 112, a system memory 114, and an interface 116, which may (or may not) be arranged as shown. The processor 112 couples to the system memory 114 and the interface 116. Migration computing system 110, which can be implemented as a computing device, may include additional components not show, such as a power supply to provide power to the system.

Migration computing system 110 can be, for example, a server (e.g., a blade-server in a blade-server chassis, a rack server in a rack, etc.), a desktop computer, a mobile device (e.g., laptop computer, smartphone, personal digital assistant, tablet computer, automobile computing system, or any other mobile computing device), a storage device (e.g., a disk drive array, a fiber channel storage device, an Internet Small Computer Systems Interface (iSCSI) storage device, a tape storage device, a flash storage array, a network attached storage device, etc.), a network device (e.g., switch, router, multi-layer switch, etc.), a virtual machine, a virtualized computing environment, a logical container (e.g., for one or more applications), an Internet of Things (IoT) device, an array of nodes of computing resources, a supercomputing device, a data center or any portion thereof, or a digital sensor.

In implementations, any or all of the aforementioned can be combined to create a system of such devices or partitioned into separate logical devices, collectively called the migration computing system 110. Other types of computing devices can be used without departing from the scope of implementations described herein.

In an implementation, processor 112 is an integrated circuit, a single-core processor, a microcontroller, or a multi-core processor for processing instructions. Processor 112 can be a general-purpose processor configured to execute program code included in software executing on the migration computing system 110. Processor 112 can be a special-purpose processor where instructions are incorporated into the processor design. Although one processor 112 is shown in FIG. 1, migration computing system 110 can include any number of processors without departing from the scope of implementations disclosed herein. In implementations, the migration program or set of instructions for migration is executed by processor 112.

Processor 112 can monitor application states, maintain operational status, and manage data extraction for stateful applications during migration. It can also manage deployment operations, allocate resources, and synchronize states during transitions. Processor 112 can implement migration strategies, translate standardized inputs into environment-specific commands, and coordinate rollback operations when needed. Further, it can verify compatibility between source environment 120 and target environment 130 before initiating migration sequences.

In an implementation, system memory 114 is volatile memory, non-volatile memory, or both. In implementation, system memory 114 is a random-access memory (RAM), cache memory, persistent storage, a hard disk, an optical drive, flash memory, or the like. System memory 114 can store migration plans, templates, operational data, and execution parameters, as well as configuration data for expert-defined migration procedures and state information during migration operations. In an implementation, system memory 114 can be any storage unit or device (e.g., a file system, database, collection of tables, RAM, or any other storage mechanism or medium) for storing data. Further, system memory 114 can include multiple different storage units or devices. The multiple storage units or devices may or may not be the same type or located at the exact physical location. System memory 114 can also maintain logs of migration operations and rollback points. In implementations, system memory 114 is configured to store instructions to be executed by processor 112 to perform the methods disclosed herein.

In an implementation, interface 116 is a touchscreen, a keyboard, a mouse, a microphone, a touchpad, an electronic pen, a motion sensor, or any other input device. In implementations, interface 116 is a screen (e.g., a liquid crystal display (LCD), a plasma display, a touch screen, a cathode ray tube (CRT) monitor, a projector, or other display device), a printer, external storage, or any other output device. Interface 116 can allow a user to interact with other devices, such as a device where the migration plan is to be executed. In implementation, interface 116 is an input and an output device. Interface 116 can be locally or remotely coupled to the processor 112 and system memory 114. Many different types of computing devices exist, and the aforementioned interface 116 can take other forms.

In an implementation, interface 116 can facilitate coupling migration computing system 110 to a network (e.g., a local area network (LAN), a wide area network (WAN) such as the Internet, mobile network, or any other type of network) or another device, such as another computing device. Interface 116 can perform or facilitate receipt or transmission of wired or wireless communications using wired or wireless transceivers. Interface 116 can enable expert configuration input and operator commands. It can receive standardized parameters, such as target environment location, migration strategy selection, and target application designation. Interface 116 can provide status updates and alerts during migration operations.

Methods described herein can be implemented using computer-executable instructions stored in system memory 114 or otherwise available from computer-readable media. Such instructions can include, for example, instructions and data that cause or otherwise configure processing devices, a computer, a special-purpose computer, or a processing device to perform a particular function or group of functions. Portions of computer resources used can be accessible over a network. The computer-executable instructions can include binaries and intermediate format instructions such as assembly language, firmware, source code, etc. Examples of computer-readable media that can be used to store instructions, information used, or information created during methods according to described examples include magnetic or optical disks, flash memory, USB devices provided with non-volatile memory, networked storage devices, or the like.

All or any portion of the components of the migration computing system 110 can be implemented in circuitry. For example, the components can include or can be implemented using electronic circuits or other electronic hardware, which can include one or more programmable electronic circuits (e.g., microprocessors, GPUs, DSPs, CPUs, or other suitable electronic circuits) or can include or be implemented using computer software, firmware, or any combination thereof, to perform the various operations described herein. In some aspects, computer-readable storage devices, mediums, and memories can include a cable or wireless signal containing a bit stream and the like.

The source environment 120 and target environment 130 represent different computing platforms between which applications may be migrated. The source environment 120 can include virtual machines, containers, or cloud-based applications operating in a first configuration. In contrast, the target environment 130 can include a different configuration of virtual machines, containers, or cloud platforms. For example, the source environment 120 can maintain applications in virtual machines while the target environment 130 can be configured to operate containerized versions of these applications.

Migration computing system 110 can coordinate the transition of applications and data from the source environment 120 to the target environment 130 while maintaining system consistency through continuous monitoring and automated recovery capabilities. Through this integrated architecture, the migration system 100 can enable consistent migration operations across diverse computing environments while maintaining operational reliability through automated verification and rollback mechanisms.

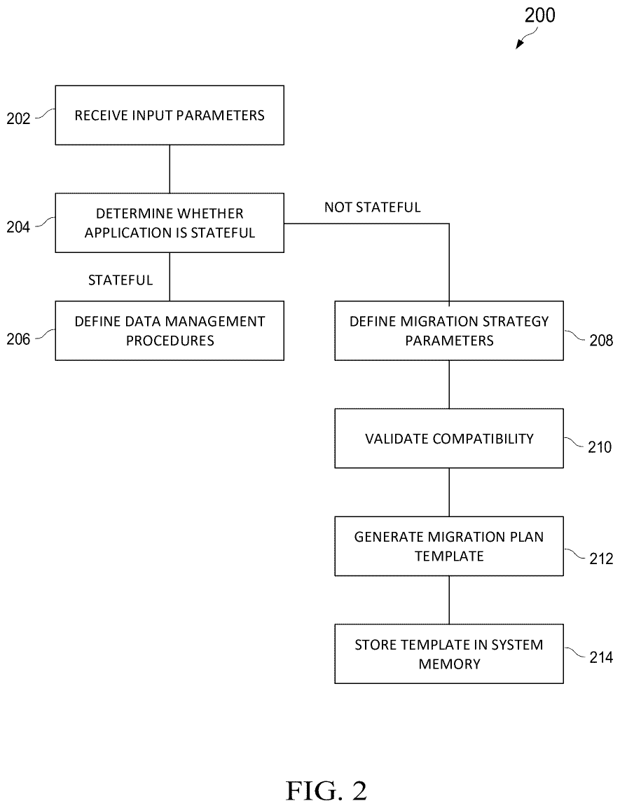

FIG. 2 illustrates a flowchart of an implementation method 200 directed to the design phase of a migration plan. The design phase enables expert users to create standardized migration procedures that operators can repeatedly execute. During the design phase, migration parameters are defined, validated, and stored as templates for future use. The design phase separates complex configuration tasks from routine execution, allowing efficient scaling of migration operations across multiple application instances while maintaining operational consistency.

At step 202, input parameters defining source and target configurations are received for migration plan development. In implementations, the parameters are received by the interface 116. The input parameters can specify source application characteristics, including whether applications operate as virtual machines or containers. The parameters can include database types, network functions, and application configurations operating in the source environment 120.

The interface 116 can accept target environment specifications indicating destination platforms for migrated applications. The specifications can include container deployment parameters for private data center environments, cloud platform configurations for public environments such as Amazon or Azure, or vendor-specific implementation details. For cloud platform migrations, the parameters can specify transitions between public cloud and private data center environments based on operational costs and resource utilization.

For example, applications initially deployed in public clouds may be migrated to private data centers when increased transaction volumes make cloud operations cost-prohibitive. Conversely, applications in private data centers may be configured for migration to public clouds to handle periodic resource bursts without maintaining maximum capacity infrastructure on-premise.

The parameters can define equivalent application mappings for vendor replacement scenarios, enabling transitions between different vendors' implementations of the same network function or database service. The input parameters can include data persistence requirements indicating whether applications maintain state information that requires preservation during migration. They can also specify data extraction procedures, state preservation methods, and restoration sequences for stateful applications. The parameters can also define operational constraints, such as maintaining service availability during transitions, handling traffic management during migration, and implementing specific rollback points.

Expert users can define additional migration parameters, including resource allocation requirements, environment-specific configurations, and compatibility verification criteria. The parameters enable validation of migration feasibility between source environment 120 and target environment 130 while maintaining operational consistency throughout the transition process.

Step 204 includes determining whether the application maintains persistent data states requiring preservation during migration. The determination can influence subsequent migration strategy selection, as stateless applications can support direct replacement approaches while stateful applications can require parallel operation during transition periods to maintain data consistency. Through interface 116, expert users can specify additional data handling requirements based on application-specific considerations such as data volume, consistency requirements, and operational constraints.

For example, applications such as stateless File Transfer Protocol (FTP) servers without stored files can be migrated directly between environments without data management procedures. In such cases, method 200 can proceed directly to migration strategy definition as the application can be removed from source environment 120 and recreated in target environment 130 without additional data handling.

At step 206, data management procedures are defined for stateful applications. For applications maintaining persistent data, processor 112 can generate specific data handling sequences based on the application type and environment requirements. The procedures can include pre-migration data extraction from the source environment 120, intermediate storage management in system memory 114, and post-migration data restoration in the target environment 130.

The data management procedures can be configured to account for different migration scenarios. For example, in cases where applications serve the same IP address, processor 112 can define procedures to extract data before removing the source application, as both versions cannot operate simultaneously. For other scenarios, processor 112 can define procedures allowing parallel operation, where data can be synchronized between source environment 120 and target environment 130 during the transition period.

Processor 112 can be configured to generate data management procedures in standardized formats, such as YAML configurations or Ansible scripts, stored in system memory 114 and reused across multiple migration instances. These procedures can specify how to handle data backup creation, data export sequences, verification of data integrity, and restoration processes. For database migrations, the procedures can include specific commands for exporting schema structures, transferring stored data, and validating successful restoration.

Through interface 116, expert users can define additional data handling requirements such as backup retention policies, data verification steps, and rollback procedures. Processor 112 can incorporate the requirements into the data management procedures while maintaining standardized execution formats that enable consistent implementation by operators during the execution phase.

At step 208, migration strategy parameters are defined based on application characteristics and operational requirements. In implementations, processor 112 is configured to support distinct migration strategies, such as Canary, Blue-Green, and Standard. Each strategy can provide different approaches for transitioning applications between the source environment 120 and the target environment 130.

For example, in the Canary strategy, processor 112 defines parameters enabling parallel operation of applications in source environment 120 and target environment 130 during the transition period. This strategy allows applications to coexist while data or traffic gradually transfers between environments. The parameters specify how the applications maintain concurrent operation, manage shared resources, and coordinate state synchronization during migration.

As another example, in the Blue-Green strategy, processor 112 defines parameters in a sequential replacement approach where processor 112 coordinates the removal of applications from source environment 120 before deployment in target environment 130. This strategy can be implemented when applications cannot operate simultaneously, such as when both versions attempt to use the same IP address or system resources. The parameters specify the sequence of operations, timing constraints, and resource management procedures.

As yet another example, for cloud-native applications supporting direct upgrades, processor 112 defines Standard strategy parameters utilizing built-in commands such as Helm upgrade. The parameters specify how applications can transform from one version to another through standardized upgrade procedures. The Standard strategy may apply when containerized applications follow cloud-native design patterns that enable direct version transitions.

Through interface 116, expert users can specify which strategy best suits their application requirements and operational constraints. Processor 112 can be configured to validate strategy selection against application characteristics and environment capabilities to ensure feasible migration paths. The selected strategy parameters can be stored in system memory 114 as part of the migration plan template for consistent execution across multiple instances.

At step 210, compatibility between source environment 120 and target environment 130 is validated through a series of verification checks performed by processor 112. The validation process ensures that migration plans can be executed successfully while maintaining application functionality and operational requirements.

In implementations, processor 112 evaluates whether applications in source environment 120 can operate in target environment 130 based on the selected migration strategy. For example, in cloud-native applications, processor 112 verifies if the application supports direct upgrades through standard commands. Applications requiring specific data management procedures or parallel operation capabilities can be validated against the target environment's ability to support these requirements. Processor 112 can be configured to determine whether applications claiming to be cloud-native but requiring custom data migration scripts are compatible with standard upgrade procedures.

For vendor replacement scenarios, processor 112 can be configured to validate whether applications in target environment 130 provide equivalent functionality to those in source environment 120. The validation can include checking whether vendor applications can maintain operational consistency during and after migration. When migrating between cloud platforms, such as from private data centers to public clouds like Amazon or Azure, processor 112 can verify whether the target environment 130 can support the required resources and configurations.

At step 212, a migration plan template is generated based on validated parameters and configurations. The template standardizes migration procedures into a format that enables consistent execution by operators who may not possess deep technical expertise in application migration processes.

In implementations, processor 112 structures the migration plan template around three standardized input parameters: target environment location, migration strategy selection, and target application designation. These parameters consolidate complex migration requirements into simplified inputs that operators can specify during the execution phase. For example, operators may select on-premise data centers or cloud platforms for the target location, choose from pre-validated Canary, Blue-Green, or Standard migration strategies, and specify which applications will undergo migration.

In an implementation, processor 112 incorporates data management procedures into the template for stateful applications using standardized formats such as YAML configurations or Ansible scripts. These procedures are packaged within the template in a way that maintains their technical complexity while presenting simplified execution interfaces to operators. The template may include configuration files that define pre-migration actions, intermediate procedures, and post-migration verification steps.

In implementations, processor 112 structures the template to enable the application of the same migration plan across multiple instances while maintaining consistent execution procedures. Through interface 116, expert users can verify that templates properly encapsulate migration procedures while presenting appropriate parameter options to operators. Processor 112 can store completed templates in system memory 114, making them available for repeated use across different migration scenarios involving compatible applications and environments.

At step 214, the completed migration plan template is stored in system memory 114 through processor 112, making it available for repeated execution across multiple application instances. The storage process can include cataloging templates based on compatibility with different application types and target environments.

In implementations, processor 112 maintains associations between stored templates and their applicable use cases in system memory 114. For example, a template for migrating database applications from virtual machines to containers may be flagged as compatible with multiple database instances across different locations. Similarly, templates for vendor replacement scenarios may be marked as suitable for specific pairs of vendor applications, enabling consistent migration procedures when replacing one vendor's implementation with another's.

When templates are stored, processor 112 can include validation criteria that enable automatic compatibility checking during the execution phase. The criteria can help prevent the application of templates to incompatible scenarios, such as attempting to use container-specific migration procedures with applications that cannot operate in containerized environments. Through interface 116, operators can access stored templates and view their compatibility parameters without requiring a detailed understanding of the underlying migration complexities.

The storage mechanism supports the scaling of migration operations by enabling a single template, created once by an expert user, to be applied repeatedly by operators across numerous application instances. For example, an organization migrating hundreds of database instances from virtual machines to containers can utilize the same stored template across all compatible instances, maintaining consistent procedures while reducing operational complexity and expert resource requirements.

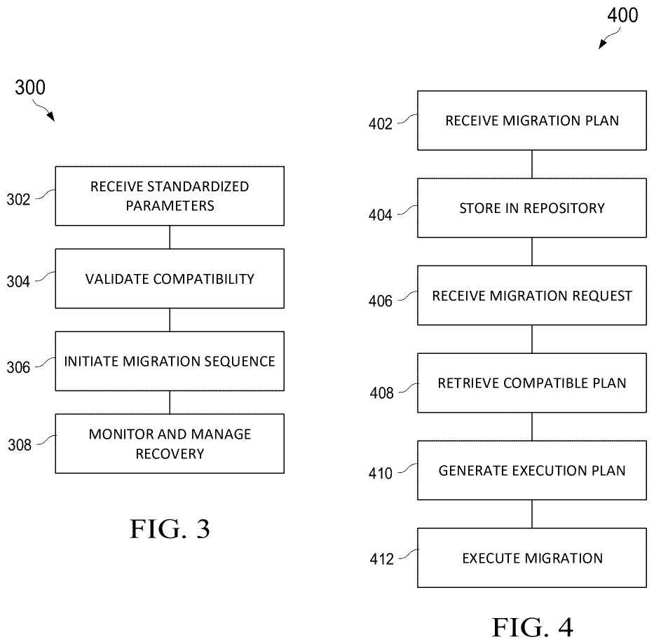

FIG. 3 illustrates a flowchart of an embodiment method 300 directed to an execution phase of the migration plan. While method 200 enables expert users to create migration plan templates through detailed configuration of data management procedures and migration strategies, method 300 enables non-expert operators to execute the pre-configured templates through simplified parameters. The separation between expert configuration and operator execution reduces operational complexity while maintaining consistent migration procedures across multiple application instances.

The execution phase leverages migration plan templates stored in system memory 114 during step 214 of method 200. The templates, previously validated and configured by expert users, encapsulate complex migration procedures within standardized execution formats. Through this approach, operators who may not possess deep technical expertise in application migration can implement complex transitions between source environment 120 and target environment 130 while maintaining operational consistency.

At step 302, standardized parameters are received for migration execution: target environment location, migration strategy selection, and target application designation. In an implementation, interface 116 receives these parameters from an operator.

The target environment location parameter specifies the destination platform for migrated applications. The location may include private data centers, public cloud platforms like Amazon or Azure, or hybrid environments for handling resource bursts. For example, the migration strategy selection indicates whether to implement Canary, Blue-Green, or Standard approaches validated during the design phase. The target application designation identifies which applications will undergo migration, such as databases, network functions, or other applications verified as compatible with the selected migration plan.

The standardized parameter approach enables the execution of complex migrations without detailed knowledge of underlying technical requirements. In an implementation, operators can use interface 116 to select migration plan templates created during method 200, specify target locations, choose pre-validated strategies, and identify applications for migration.

Once the parameters are received, at step 304, compatibility is validated between the selected migration plan and specified application before proceeding with execution. In an implementation, processor 112 performs the validation process.

The compatibility check can include verification of resource requirements and operational constraints. The validation ensures equivalent functionality between source and target applications for vendor replacement scenarios. Verification can include checking whether target environments can support required resources and configurations when migrating between cloud platforms. In an implementation, processor 112 compares the requirements against validation criteria stored in system memory 114 during the design phase.

The validation process helps prevent the application of migration plans to incompatible scenarios. For example, attempting to use container-specific migration procedures with applications that cannot operate in containerized environments would be identified and prevented. In an implementation, processor 112 blocks the execution of incompatible migrations and provides notification through the interface 116, allowing operators to select alternative migration plans or strategies.

At step 306, after validation confirms compatibility, the migration sequence initiates according to the selected strategy. In an implementation, processor 112 executes the migration sequence.

For the Canary strategy, the new application is created in the target environment while the original application continues running in the source environment. This approach enables applications to coexist during the transition period, allowing for gradual migration of data or traffic between environments. In an implementation, processor 112 maintains both applications in parallel until the transition is completed.

For the Blue-Green strategy, the original application is removed first, followed by creating the new application. The sequential approach is utilized when applications cannot operate simultaneously, such as when both versions attempt to use the same IP address or system resources. In an implementation, processor 112 coordinates the removal and creation sequence to maintain system consistency.

Under the Standard strategy, direct upgrade commands are executed for truly cloud-native applications. This approach applies when applications support built-in upgrade capabilities, such as the Helm upgrade command in containerized environments. In an implementation, processor 112 executes the standardized upgrade commands without requiring parallel operation or sequential replacement.

The selected strategy implements previously defined and validated migration procedures during method 200. In an implementation, processor 112 executes these procedures while maintaining the simplified interface that enables non-expert operators to manage complex migrations through standardized parameters.

At step 308, migration progress is monitored throughout the execution sequence, with automated recovery procedures available if issues occur. In an implementation, processor 112 performs continuous monitoring and manages recovery operations.

Monitoring for migrations involving stateful applications includes verifying data consistency during transfer operations. If data synchronization fails or becomes corrupted during the transition, automated rollback procedures can restore the system to its initial state. In an implementation, processor 112 uses validation points defined during method 200 to verify successful data migration.

The monitoring process varies based on the selected migration strategy. For Canary deployments, original and new applications are monitored to ensure proper operation during coexistence. Monitoring focuses on successfully removing the original application before validating the new deployment for Blue-Green deployments. For Standard upgrades, the monitoring verifies the successful execution of cloud-native upgrade commands. In an implementation, processor 112 applies strategy-specific monitoring procedures while maintaining the ability to initiate recovery operations.

Automated recovery capabilities enable consistent handling of migration issues without requiring expert intervention. The automation allows non-expert operators to manage complex migrations while maintaining system stability through built-in rollback mechanisms. In an implementation, processor 112 can restore applications and data to their pre-migration state if any part of the migration sequence fails to complete successfully.

FIG. 4 illustrates a flowchart of an embodiment method 400 for managing and executing migration plans. Method 400 enables non-expert operators to reuse expert-defined migration plans through standardized procedures, separating complex configuration tasks from routine execution operations.

At step 402, a migration plan is received for transitioning applications between different environments. The migration plan represents expert knowledge consolidated into standardized procedures that can be repeatedly executed. In an implementation, processor 112 receives migration plans through the interface 116.

The migration plans may define procedures for various transition scenarios. For database applications, plans may specify how to, for example, migrate Oracle or Postgres databases from virtual machines to containers. For network functions, plans may detail transitions between vendor implementations, such as replacing Nokia components with equivalent Ericsson solutions when cost advantages arise. In an implementation, processor 112 processes these specific migration requirements into standardized formats.

The received plans incorporate an expert understanding of application characteristics and operational constraints. For stateful applications, plans include data management procedures defining how to extract, preserve, and restore persistent data during migration. For applications serving the same IP address, plans can specify whether to implement sequential replacement or parallel operation approaches. In an implementation, processor 112 maintains the expert-defined procedures while organizing them into standardized execution formats.

The migration plans can account for cloud platform transitions driven by cost considerations. Plans may specify procedures for moving applications from public clouds to private data centers when transaction volumes make cloud operations cost-prohibitive or enable burst capacity through hybrid deployments. In an implementation, processor 112 processes these cost-driven migration requirements while maintaining consistent execution procedures.

At step 404, the received migration plan is stored in a repository of reusable migration plans. The storage approach enables a single migration plan, created once by an expert, to be applied repeatedly across multiple application instances. In an implementation, processor 112 stores the migration plan in system memory 114.

The stored plans maintain standardized formats using set configuration files that define the migration procedures. These files may include YAML configurations or Ansible scripts that specify pre-migration actions, intermediate procedures, and post-migration verification steps. In an implementation, processor 112 organizes the configuration files to maintain their technical complexity while presenting simplified execution interfaces.

The repository associates stored plans with their applicable use cases and compatibility requirements. For example, plans for database migrations may be flagged as compatible with multiple database instances across different locations. In contrast, plans for vendor replacements may be marked as suitable for specific pairs of vendor applications. In an implementation, processor 112 maintains the associations in system memory 114 to enable appropriate plan selection during execution.

The storage mechanism can support the scaling of migration operations by reducing repeated expert involvement. Rather than requiring expert configuration for each migration instance, the stored plans enable non-expert operators to execute pre-validated procedures consistently. In an implementation, processor 112 maintains the stored plans in formats that support repeated execution while preserving the technical procedures defined during expert configuration.

At step 406, a request to migrate a target application is received through a simplified operator interface. The request consolidates complex migration requirements into standardized parameters that operators can specify without deep technical expertise. In an implementation, interface 116 receives the parameters from an operator.

In an implementation, the first parameter specifies the target environment location, enabling operators to select between on-premises data centers, public clouds like Amazon or Azure, or hybrid environments to handle resource bursts. For example, an operator can designate the migration of applications to private infrastructure when cloud costs become prohibitive or to public clouds for periodic capacity needs. In an implementation, interface 116 processes location selections without requiring operators to understand detailed environment configurations.

In an implementation, the second parameter indicates migration strategy selection between Canary, Blue-Green, or Standard approaches. The selection determines whether applications will operate in parallel during the transition (i.e., Canary), undergo sequential replacement (i.e., Blue-Green), or execute direct upgrades (i.e., Standard). In an implementation, interface 116 captures strategy selections without requiring operators to understand the technical implications of each approach.

In an implementation, the third parameter designates which applications will undergo migration. This enables operators working different shifts to initiate migrations without virtualization or cloud technologies expertise. For example, a morning shift operator can select applications for migration while the system manages complex procedures like data extraction, traffic management, and vendor-specific configurations. In an implementation, interface 116 processes application designations while maintaining the simplified interface that enables non-expert execution of expert-defined procedures.

At step 408, a compatible migration plan is retrieved from the repository based on the characteristics of the target application. The compatibility check ensures that migration plans align with application capabilities and operational requirements. In an implementation, processor 112 evaluates compatibility between applications and stored migration plans.

For cloud-native applications, the compatibility check can verify whether applications truly support direct upgrade capabilities. Applications claiming to be cloud-native but requiring custom data migration scripts may be flagged as incompatible with Standard strategy plans. In an implementation, processor 112 uses verification to measure actual cloud-native readiness and prevent the application of inappropriate migration approaches.

For vendor replacement scenarios, compatibility checking can ensure equivalent functionality between source and target implementations. For example, when replacing Nokia components with Ericsson alternatives, the system can verify that stored migration plans match the specific vendor pair and maintain operational consistency. In an implementation, processor 112 validates vendor-specific requirements before allowing plan retrieval.

The compatibility verification can prevent scenarios where migration plans may fail during execution. For example, attempts to apply container-specific migration procedures to applications that cannot operate in containerized environments can be identified and blocked. Similarly, plans requiring specific data management procedures are retrieved for applications capable of supporting those procedures. In an implementation, processor 112 verifies to maintain system stability and prevent migration failures requiring recovery operations.

At step 410, an executable migration plan is generated by configuring the retrieved migration plan for the target application. This step transforms expert-defined templates into executable procedures through the application of the standardized parameters received from operators. In an implementation, processor 112 generates the executable plan while maintaining the technical complexity defined during the design phase.

The configuration can incorporate data management procedures defined by experts using standardized formats like YAML or Ansible scripts for stateful applications. When applications serve the same IP address, the configuration can specify whether data must be extracted before removing the source application or whether parallel operation is possible. In an implementation, processor 112 incorporates the data handling requirements while maintaining simplified execution interfaces.

The configuration process adapts migration procedures based on the selected strategy. In an implementation for Canary deployments, the executable plan enables parallel operation of applications with gradual traffic or data transfer. In an implementation for Blue-Green deployments, the plan coordinates the removal of original applications before new deployment. In an implementation, the plan can implement direct upgrade commands for truly cloud-native applications for Standard deployments. In an implementation, processor 112 configures strategy-specific procedures that operators can execute without understanding the underlying technical requirements.

The executable plan can maintain built-in validation points and recovery procedures defined during expert configuration. The automated capabilities enable non-expert operators to manage complex migrations while maintaining system stability. In an implementation, processor 112 incorporates the safeguards into the executable plan while preserving the simplified three-parameter interface for operator execution.

At step 412, the migration plan executes to transition the target application between source environment 120 and target environment 130. The execution implements expert-defined procedures through standardized operations that maintain system stability. In an implementation, processor 112 manages the migration execution sequence.

In an implementation for Canary strategy migrations, the execution creates new applications while maintaining original versions during the transition period. This allows applications to coexist while data or traffic gradually transfers between environments. For example, both versions may operate simultaneously when migrating database applications while ensuring data consistency. In an implementation, processor 112 coordinates parallel operations until the transition completes.

In an implementation for Blue-Green strategy migrations, the execution removes original applications before deploying new versions. The sequential approach applies when applications cannot operate simultaneously, such as when both versions attempt to use the same IP address. For example, when replacing one vendor's implementation with another's, the execution ensures a clean transition between versions. In an implementation, processor 112 manages the removal and deployment sequence.

In an implementation for Standard strategy migrations, the execution implements direct upgrade commands for cloud-native applications. However, if issues arise during execution, such as failed upgrades or data synchronization problems, automated rollback procedures can restore systems to their initial state. In an implementation, processor 112 monitors migration progress and initiates recovery operations without requiring expert intervention, enabling non-expert operators to maintain system stability throughout the migration process.

Through this approach, method 400 enables organizations to leverage expert knowledge across multiple migration operations while reducing operational complexity through standardized execution procedures. For example, when migrating hundreds of database instances from virtual machines to containers, a single expert-defined template can be executed repeatedly by operators across all compatible instances. In an implementation, processor 112 maintains consistent execution procedures while reducing the need for repeated expert involvement.

The separation between expert configuration and operator execution provides cost advantages in large-scale migrations. Organizations can utilize lower-cost operators to execute pre-validated procedures rather than requiring expensive expert resources to perform each migration. For example, when replacing vendor implementations due to cost considerations, operators can execute expert-defined plans to migrate hundreds of instances without deep technical expertise in either solution. In an implementation, processor 112 enables this operational efficiency through simplified interfaces and automated safeguards.

The standardized approach supports migrations between diverse computing environments while maintaining operational consistency. Whether transitioning between public clouds and private data centers for cost optimization, implementing hybrid deployments for resource bursts, or replacing vendor implementations for better pricing, the same three-parameter interface enables consistent execution. In an implementation, processor 112 manages these varied migration scenarios through templates that encapsulate expert knowledge while presenting simplified operator controls.

Method 400 enables organizations to scale migration operations efficiently across multiple applications and environments. By combining expert-defined procedures with simplified operator execution, organizations can maintain consistent migration practices while reducing operational complexity and resource requirements. In an implementation, processor 112 supports this scaling through automated validation, monitoring, and recovery capabilities that maintain system stability throughout migration operations.

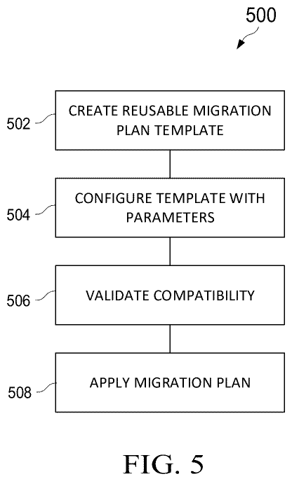

FIG. 5 illustrates a flowchart of an embodiment method 500 directed to creating and applying reusable migration plan templates. Method 500 enables experts to define standardized migration procedures that non-expert operators can repeatedly execute across different computing environments while maintaining operational consistency.

At step 502, a reusable migration plan template is created specifying transition steps between different environments. The template consolidates expert knowledge into standardized formats that enable consistent execution by non-expert operators. In an implementation, processor 112 creates templates through the interface 116.

The template structure includes configuration files that define migration procedures. For example, the files may use standardized formats such as YAML configurations or Ansible scripts to specify pre-migration actions, intermediate procedures, and post-migration verification steps. These files define data extraction commands, state preservation methods, and restoration sequences for stateful applications. In an implementation, processor 112 organizes the configuration files to maintain their technical complexity while presenting simplified execution interfaces.

The template may support various migration scenarios based on operational requirements and cost considerations. For virtual machine to container transitions, templates can define procedures for migrating applications like databases or network functions to containerized environments. For cloud platform movements, templates can specify transitions between public clouds and private data centers based on cost optimization needs, such as moving applications to private infrastructure when cloud costs become prohibitive or enabling cloud bursting for periodic capacity requirements. In an implementation, processor 112 maintains these procedures in formats that support consistent execution across different environments.

The templates can also support vendor replacement scenarios where organizations may transition between different implementations of the same function. For example, templates may define procedures for replacing Nokia components with Ericsson alternatives when cost advantages arise. These templates enable organizations to maintain leverage with vendors by simplifying the replacement process. In an implementation, processor 112 creates templates that maintain operational consistency while enabling transitions between different vendor implementations.

At step 504, the migration plan template is configured through standardized parameters that enable non-expert operators to execute complex migrations. The parameters consolidate technical requirements into simplified inputs that operators can specify without deep virtualization or migration technologies expertise. In an implementation, processor 112 applies these parameters while maintaining simplified execution interfaces.

In an implementation, the first parameter, target environment location, enables selection between private data centers, public clouds like Amazon or Azure, or hybrid environments. This parameter supports cost-driven migrations, such as moving applications to private infrastructure when transaction volumes make cloud operations cost-prohibitive or enabling cloud bursting to handle periodic resource demands without maintaining maximum capacity on-premise. In an implementation, processor 112 processes location selections without requiring operators to understand detailed environment configurations.

In an implementation, the second parameter, migration strategy selection, determines whether to implement Canary, Blue-Green, or Standard approaches based on application characteristics. The configuration may specify a Blue-Green strategy for applications serving the same IP address, as both versions cannot operate simultaneously. For applications supporting parallel operation, the Canary strategy enables a gradual transition of data or traffic. For truly cloud-native applications, the Standard strategy enables direct upgrades. In an implementation, processor 112 configures strategy-specific procedures while maintaining simplified operator controls.

In an implementation, the third parameter, target application designation, identifies which applications will undergo migration while incorporating any specific data management requirements. For stateful applications, the configuration includes procedures for extracting data before removing source applications, managing intermediate storage, and restoring data in target environments. The configuration may proceed directly to application replacement for stateless applications like FTP servers without stored files. In an implementation, processor 112 incorporates these requirements while enabling non-expert operators to execute migrations through standardized interfaces.

At step 506, compatibility is validated between the configured migration plan and the target application. The validation process measures actual application capabilities against claimed functionalities to ensure appropriate migration strategy selection. In an implementation, processor 112 performs compatibility verification before allowing migration execution.

In an implementation for cloud-native applications, the validation process determines whether applications truly support direct upgrades through standard commands like Helm upgrade. Applications claiming to be cloud-native but requiring custom data migration scripts can be flagged as not yet fully cloud-native, preventing the use of Standard strategy plans. The verification serves as a measure of cloud-native readiness, helping organizations identify applications that do not fully follow cloud design patterns. In an implementation, processor 112 evaluates these capabilities to ensure proper strategy selection.

In implementations, validation ensures equivalent functionality between source and target implementations for vendor replacement scenarios. For cost advantages, the system can verify operational compatibility between implementations when replacing vendor applications, such as transitioning from Nokia to Ericsson components. The validation can help organizations maintain service consistency when leveraging vendor alternatives. In an implementation, processor 112 verifies functional equivalency before allowing vendor replacement migrations.

The validation can prevent the application of inappropriate migration procedures that could lead to failed migrations requiring recovery operations. For example, attempts to use container-specific migration procedures with applications that cannot operate in containerized environments can be identified and blocked. Similarly, when applications serve the same IP address, validation can ensure appropriate sequential replacement strategies selection rather than parallel operation approaches. In an implementation, processor 112 maintains system stability by preventing incompatible migrations before execution begins.

At step 508, the configured migration plan is applied using specific migration strategies based on application characteristics and operational requirements. The strategy selection determines how applications transition between environments while maintaining system stability. In an implementation, processor 112 executes the migration according to the selected strategy.

The Canary strategy creates a new application while maintaining the original application during the transition. The approach enables both versions to coexist, allowing gradual data transfer or traffic between environments. For example, when migrating database applications, both versions may operate in parallel while ensuring data consistency between source environment 120 and target environment 130. In an implementation, processor 112 maintains parallel operations until the transition is completed.

The Blue-Green strategy implements a sequential approach, removing the original application before creating the new version. This strategy applies when applications cannot operate simultaneously, such as in cases where both versions would attempt to use the same IP address or system resources. For example, when migrating between vendor implementations, the original version must be removed before deploying its replacement. In an implementation, processor 112 coordinates removal and creation sequences to maintain system consistency.

The Standard strategy executes direct upgrades for truly cloud-native applications through built-in commands like Helm upgrade. However, if issues arise during execution, such as failed upgrades or data synchronization problems, automated rollback procedures can restore systems to their initial state. The automated recovery enables non-expert operators to maintain system stability without expert intervention. In an implementation, processor 112 monitors migration progress and initiates recovery operations when needed.

Through this approach, method 500 enables organizations to leverage expert knowledge across multiple migration operations while reducing operational complexity through standardized execution procedures. For example, when migrating hundreds of database instances from virtual machines to containers, an expert creates a template only once, which non-expert operators can execute repeatedly. In an implementation, processor 112 maintains consistent execution procedures while reducing expert involvement in routine migrations.

Separating template creation and application-specific configuration provides significant cost advantages in large-scale migrations. Rather than requiring expensive expert resources for each migration instance, organizations can utilize lower-cost operators to execute pre-validated procedures through simplified three-parameter interfaces. For example, when replacing vendor implementations to reduce costs, operators can execute expert-defined templates to migrate hundreds of instances without deep technical expertise in either vendor's solution. In an implementation, processor 112 enables this operational efficiency through automated validation and recovery capabilities.

The standardized approach can support migrations across diverse computing environments while maintaining operational consistency. Whether transitioning between public clouds and private data centers for cost optimization, implementing hybrid deployments for resource bursts, or replacing vendor implementations for better pricing, the same template structure enables consistent execution. The ability to measure cloud-native readiness through validation helps organizations identify applications that may require additional preparation before migration. In an implementation, processor 112 manages these varied scenarios through templates that encapsulate expert knowledge while presenting simplified operator controls.

Method 500 demonstrates how organizations can scale migration operations efficiently by combining expert-defined templates with simplified operator execution. This approach reduces operational complexity and resource requirements while maintaining consistent migration practices through automated validation, monitoring, and recovery capabilities. In an implementation, processor 112 supports this scaling through standardized procedures that enable non-expert operators to maintain system stability throughout migration operations.

It is noted that all steps outlined in the flow charts are not necessarily required and can be optional. Further, changes to the arrangement of the steps, removal of one or more steps and path connections, and addition of steps and path connections are similarly contemplated.

Although this disclosure describes or illustrates particular operations as occurring in a particular order, this disclosure contemplates the operations occurring in any suitable order. Moreover, this disclosure contemplates any suitable operations being repeated one or more times in any suitable order. Although this disclosure describes or illustrates particular operations as occurring in sequence, this disclosure contemplates any suitable operations occurring at substantially the same time, where appropriate. Where appropriate, any suitable operation or sequence described or illustrated herein may be interrupted, suspended, or otherwise controlled by another process, such as an operating system or kernel. The acts can operate in an operating system environment or as stand-alone routines occupying all or a substantial part of the system processing.

While this disclosure has been described with reference to illustrative implementations, this description is not intended to be construed in a limiting sense. Various modifications and combinations of the illustrative implementations, as well as other implementations of the disclosure, will be apparent to persons skilled in the art upon reference to the description. Therefore, the appended claims are intended to encompass any such modifications or implementations.

What is claimed is:

1. A computer system for managing application migrations, comprising:
a non-transitory memory storage comprising instructions; and
a processor in communication with the non-transitory memory storage, wherein the processor executes the instructions to:
receive a migration plan for transitioning applications between different environments,
store the migration plan in a repository of re-usable migration plans,
receive a request to migrate a target application,
retrieve a compatible migration plan design from the repository based on characteristics of the target application,
generate an executable migration plan by configuring the retrieved migration plan design for the target application, and
execute the migration plan to transition the target application between a source environment and a target environment.

2. The computer system of claim 1, wherein the processor executes the instructions to validate compatibility between the target application and the retrieved migration plan design before generating the executable migration plan.

3. The computer system of claim 1, wherein the processor executes the instructions to determine whether the target application is stateful or stateless.

4. The computer system of claim 3, wherein for stateful applications, the processor executes the instructions to define data management procedures including data extraction, preservation, and restoration sequences.

5. The computer system of claim 1, wherein executing the migration plan comprises implementing a Canary strategy maintaining parallel operation during transition, a Blue-Green strategy implementing sequential replacement, or a Standard strategy executing direct upgrades.

6. The computer system of claim 1, wherein generating the executable migration plan comprises configuring a target environment location, a migration strategy selection, a target application designation, or a combination thereof.

7. The computer system of claim 1, wherein the processor executes the instructions to implement automated rollback procedures if issues arise during migration execution.

8. A non-transitory computer-readable medium storing instructions for managing application migrations, that, when executed by a processor, cause the processor to:
receive a migration plan for transitioning applications between different environments;
store the migration plan in a repository of re-usable migration plans;
receive a request to migrate a target application;
retrieve a compatible migration plan design from the repository based on characteristics of the target application;
generate an executable migration plan by configuring the retrieved migration plan design for the target application; and
execute the migration plan to transition the target application between a source environment and a target environment.

9. The non-transitory computer-readable medium of claim 8, wherein the instructions cause the processor to validate compatibility between the target application and the retrieved migration plan design before generating the executable migration plan.

10. The non-transitory computer-readable medium of claim 8, wherein the instructions cause the processor to determine whether the target application maintains persistent data states requiring preservation during migration.

11. The non-transitory computer-readable medium of claim 8, wherein executing the migration plan comprises creating a new application while maintaining an original application.

12. The non-transitory computer-readable medium of claim 8, wherein executing the migration plan comprises removing an original application before creating a new application.

13. The non-transitory computer-readable medium of claim 8, wherein the instructions cause the processor to monitor migration progress and implement automated recovery procedures if issues occur.

14. The non-transitory computer-readable medium of claim 8, wherein the migration plan includes generating configuration files defining migration procedures.

15. A computer-implemented method for managing application migrations, the method comprising:
receiving a migration plan for transitioning applications between different environments;
storing the migration plan in a repository of re-usable migration plans;
receiving a request to migrate a target application;
retrieving a compatible migration plan design from the repository based on characteristics of the target application;
generating an executable migration plan by configuring the retrieved migration plan design for the target application; and
executing the migration plan to transition the target application between a source environment and a target environment.

16. The computer-implemented method of claim 15, wherein the migration plan supports transitions between virtual machines and containers, movements between cloud platforms, replacements of vendor implementations, or a combination thereof.

17. The computer-implemented method of claim 15, wherein generating the executable migration plan comprises applying standardized parameters that enable non-expert operators to execute complex migrations.

18. The computer-implemented method of claim 15, wherein retrieving the compatible migration plan comprises verifying whether applications claiming to be cloud-native support direct upgrades through standard commands.

19. The computer-implemented method of claim 15, further comprising monitoring migration progress throughout execution sequence with an availability of an automated recovery procedure.

20. The computer-implemented method of claim 15, wherein storing the migration plan enables a single migration plan created by an expert to be repeatedly applied across multiple application instances by non-expert operators.
